(19) United States
(12) Patent Application Publication
(10) Pub. No.: US 2013/0003847 A1
(43) Pub. Date: Jan. 3, 2013

(54) Motion Prediction in Scalable Video Coding

(76) Inventors: Danny Hong, New York, NY (US); Jill Boyce, Manalapan, NJ (US)

(21) Appl. No.: 13/528,169

(22) Filed: Jun. 20, 2012

Related U.S. Application Data
(60) Provisional application No. 61/503,092, filed on Jun. 30, 2011.

(51) Int. Cl. H04N 7/32

(52) U.S. Cl. 375/240.16; 375/E07.125; 375/E07.243

(57) ABSTRACT

Disclosed are techniques for prediction of a to-be-reconstructed prediction unit of an enhancement layer using motion vector information of the base layer. A video encoder or decoder includes an enhancement layer coding loop with a predictor list insertion module. The predictor list insertion module can generate a list of motion vector predictors, or modify an existing list of motion vector predictors, such that the list includes at least one predictor that is derived from side information generated by a base layer coding loop, and has been upscaled.

### CROSS REFERENCE TO RELATED APPLICATION

This application claims priority to U.S. Ser. No. 61/503,092, titled “Motion Prediction in Scalable Video Coding,” filed Jun. 30, 2011, the disclosure of which is hereby incorporated by reference in its entirety.

### FIELD

The present application relates to video coding techniques where video is represented in the form of a base layer and one or more additional layers and where motion vector information of the base layer can be used for prediction.

### BACKGROUND

Video compression using scalable techniques in the sense used herein allows a digital video signal to be represented in the form of multiple layers. Scalable video coding techniques have been proposed and/or standardized for many years.

ITU-T Rec, H.262 02/2000 (available from International Telecommunication Union (ITU), Place des Nations, 1211 Geneva 20, Switzerland, and incorporated herein by reference in its entirety), also known as MPEG-2, for example, includes in some aspects a scalable coding technique that allows the coding of one base and one or more enhancement layers. The enhancement layers can enhance the base layer in terms of temporal resolution such as increased frame rate (temporal scalability), spatial resolution (spatial scalability), or quality at a given frame rate and resolution (quality scalability, also known as SNR scalability).

ITU Rec, H.263 version 2 (1998) and later (available from International Telecommunication Union (ITU), Place des Nations, 1211 Geneva 20, Switzerland, and incorporated herein by reference in its entirety), also includes scalability mechanisms allowing certain scalability.

ITU-T Rec. H.264 version 2 (2005) and later (available from International Telecommunication Union (ITU), Place des Nations, 1211 Geneva 20, Switzerland, and incorporated herein by reference in its entirety), and their respective ISO-IEC counterpart ISO/IEC 14496 Part 10 includes scalability mechanisms known as Scalable Video Coding or SVC, in its Annex G. SVC includes prediction mechanisms for motion vectors (and other side information such as intra prediction modes, motion partitioning, reference picture indices) as explained, for example, in Segall C., and Sullivan, G., “Spatial Scalability Within the H.264/AVC Scalable Video Coding Extension”, IEEE CSVT, Vol. 17 No. 9, September 2007, and therein specifically subsection III.B.

One aspect of video compression the prediction of motion vectors. For example, SVC specifies a mode signaled by a setting of base_mode_flag to zero, for each enhancement layer motion partition, the motion vector predictor of this sample can be the upscaled motion vector of the corresponding base layer spatial region. For each motion partition of enhancement layer data a motion_prediction_flag can determine whether the upscaled base layer motion vector is used as a predictor, or whether the current layer's spatially predicted median motion vector is used as a predictor. This predictor can be modified by the enhancement layer motion vector difference decoded from the bitstream as described below, as well as other motion prediction techniques, to generate the motion vector being applied.

SVC also specifies a second mode, signaled by base_mode_flag equal to one. For this mode of inter-layer motion prediction, the entire enhancement layer macroblock's motion information can be predicted from the corresponding base layer's block. In this case, the upscaled information is used “as is”; motion vectors, reference picture list indexes (which can be equivalent to the time-dimension in motion vectors), and partition information (the size and shape of the “blocks” to which the motion vectors apply) are all derived directly from the base layer.

In both modes, there can be overhead for signaling the presence or absence of motion vector prediction; typically up to 4 bits per enhancement layer macroblock for the motion_prediction_flags flags plus 1 additional bit for the base_mode_flag, when coding using CAVLC.

In SVC, motion vectors are coded in the bitstream as the difference between the motion vector found by the search algorithm and the motion vector predictor. The predictor can be computed as the median of the motion vectors of three neighboring blocks, if the neighbors are available. If a particular neighbor is unavailable, e.g. coded as intra, or outside the boundaries of the picture or slice, a different neighbor position is substituted, or a value of (0,0) is substituted.

At the time of writing, under development in the Joint Collaborative Team for Video Coding (JCT-VC) is High Efficiency Video Coding (HEVC). At the time of writing, the working draft of JCT-VC can be found as “Bross et. al., High efficiency video coding (HEVC) text specification draft 6, JCTVC-H1003_dK, February 2012” (henceforth referred to as “WD6” or “HEVC”), available from http://phenix.int-evry.fr/ct/doc_end_user/documents/8_SanJose/wg11/JCTVC-H1003-vdK.zip (henceforth referred to as “WD6”), which is incorporated herein by reference in its entirety.

WD6 describes techniques for non-scalable video compression, and in general, provides for motion prediction as follows:

WD6 defines a Prediction Unit (PU) as the smallest unit to which prediction can apply. With respect to motion compensation, a PU is roughly equivalent to what H.264 calls a motion partition or older video coding standards call a block. For each PU, a prediction list with one or more candidate predictors is formed, which can be referred to as candidates for motion competition. The candidate predictors include neighboring block motion vectors, and the spatially corresponding blocks in reference pictures. If a candidate predictor is not available (e.g. intra or outside the boundaries of the picture or slice), or is identical to another candidate predictor that is already on the list, it is not included in the predictor list.

The list can be created both during encoding and decoding. If there is only one candidate in the list (a state that an encoder can reach through comparison with neighboring motion vectors), then this vector is the predicting vector used for the PU. However, if there were more candidate MVs in the list, an encoder can explicitly signal an index of the candidate (thereby identifying it in the list) in the bitstream. A decoder can recreate the list using the same mechanisms as the encoder has used, and can parse from the bitstream either the information that there is no index present (in which case the single list entry is selected) or an index pointing into the list.

An encoder can select, from the predictors available from the predictor list, a predictor for the motion vector of the current PU. The selection of the predictor can be based on rate-distortion optimization principles, which are known to those skilled in the art. The tradeoff can be as follows: a cost (in terms of bits) is associated with the selection of a predictor in the list. The higher the index in the list, the higher can be the cost to code the index (measured, for example, in bits). However, the actual motion vector of the PU may not be exactly what is available in any of the list entries, and, therefore, may advantageously be coded in the form of a difference vector that can be added to the predictor vector. This difference coding also can take a certain number of bits. Finally, the residual, after motion compensated prediction, also may need to be coded, which also involves bits. An encoder can choose a combination of predictor selector coding, difference vector coding, and residual coding, so to minimize the number of bits utilized for a given quality. This process is described in McCann, Boss, Sekiguchi, Han, “HM6: High Efficiency Video Coding (HEVC) Test Model 6 Encoder Description”, JCT-VC-H1002, February 2012, available from http://phenix.int-evry.fr/jct/doc_end_user/documents/8_SanJose/wg11/JCTVC-H1002-v1.zip henceforth HM6, and specifically in sections 5.4.1 and 5.4.2.

Motion vectors earlier in the list can be coded with fewer bits than those later in the list.

When decoding a picture, the motion vectors can be stored in order to make them available later for use as spatially co-located motion vectors in the reference picture created as a side effect of the decoding.

Spatial and SNR scalability can be closely related in the sense that SNR scalability, at least in some implementations and for some video compression schemes and standards, can be viewed as spatial scalability with an spatial scaling factor of 1 in both X and Y dimensions, whereas spatial scalability can enhance the picture size of a base layer to a larger format by, for example, factors of 1.5 to 2.0 in each dimension. Due to this close relation, described henceforth is only spatial scalability.

The specification of spatial scalability in all three aforementioned standards naturally differs due to different terminology and/or different coding tools of the non-sealable specification basis, and different tools used for implementing scalability. However, an exemplary implementation strategy for a scalable encoder configured to encode a base layer and one enhancement layer is to include two encoding loops; one for the base layer, the other for the enhancement layer. Additional enhancement layers can be added by adding more coding loops. This has been discussed, for example, in Dugad, R, and Ahuja, N, “A Scheme for Spatial Scalability Using Nonsealable Encoders”, IEEE CSVT, Vol 13 No. 10, October 2003, which is incorporated by reference herein in its entirety.

Referring to FIG. 1, shown is a block diagram of such an exemplary prior art scalable encoder that includes a video signal input (101), a downsample unit (102), a base layer coding loop (103), a base layer reference picture buffer (104) that can be part of the base layer coding loop but can also serve as an input to a reference picture upsample unit (105), an enhancement layer coding loop (106), and a bitstream generator (107).

The video signal input (101) can receive the to-be-coded video in any suitable digital format, for example according to ITU-R Rec. BT.601 (1982) (available from International Telecommunication Union (ITU), Place des Nations, 1211 Geneva 20, Switzerland, and incorporated herein by reference in its entirety). The term “receive” should be interpreted widely, and can involve pre-processing steps such as filtering, resampling to, for example, the intended enhancement layer spatial resolution, and other operations. The spatial picture size of the input signal is assumed herein to be the same as the spatial picture size of the enhancement layer. The input signal can be used in unmodified form (108) in the enhancement layer coding loop (106), which is coupled to the video signal input.

Coupled to the video signal input can also be a downsample unit (102). A purpose of the downsample unit (102) is to down-sample the pictures received by the video signal input (101) in enhancement layer resolution, to a base layer resolution. Video coding standards as well as application constraints can set constraints for the base layer resolution. The scalable baseline profile of H.264/SVC, for example, allows downsample ratios of 1.5 or 2.0 in both X and Y dimensions, A downsample ratio of 2.0 means that the downsampled picture includes only one quarter of the samples of the non-downsampled picture. In certain video coding standards, the details of the downsampling mechanism can be chosen freely, independently of the upsampling mechanism. In contrast, such coding standards typically specify the filter used for up-sampling, so to avoid drift in the enhancement layer coding loop (105).

The output of the downsampling unit (102) is a downsampled version of the picture as produced by the video signal input (109).

The base layer coding loop (103) takes the downsampled picture produced by the downsample unit (102), and encodes it into a base layer bitstream (110).

Many video compression technologies rely, among others, on inter picture prediction techniques to achieve high compression efficiency. Inter picture prediction allows for the use of information related to one or more previously decoded (or otherwise processed) picture(s), known as a reference picture, in the decoding of the current picture. Examples for inter picture prediction mechanisms include motion compensation, where during reconstruction blocks of pixels from a previously decoded picture are copied or otherwise employed after being moved according to a motion vector, or residual coding, where, instead of decoding pixel values, the potentially quantized difference between a (including in some cases motion compensated) pixel of a reference picture and the reconstructed pixel value is contained in the bitstream and used for reconstruction. Inter picture prediction is a key technology that can enable good coding efficiency in modern video coding.

Conversely, an encoder can also create reference picture(s) in its coding loop.

While in non-scalable coding, the use of reference pictures is of particular relevance in inter picture prediction, in case of scalable coding, reference pictures can also be relevant for cross-layer prediction. Cross-layer prediction can involve the use of a base layer's reconstructed picture, as well as base layer reference picture(s) as a reference picture in the prediction of an enhancement layer picture. This reconstructed picture or reference picture can be the same as the reference picture(s) used for inter picture prediction. However, the generation of such a base layer reference picture can be required even if the base layer is coded in a manner, such as intra picture only coding, that would, without the use of scalable coding, not require a reference picture.

While base layer reference pictures can be used in the enhancement layer coding loop, shown here for simplicity is only the use of the reconstructed picture (the most recent reference picture) (111) for use by the enhancement layer coding loop. The base layer coding loop (103) can generate reference picture(s) in the aforementioned sense, and store it in the reference picture buffer (104).

The picture(s) stored in the reconstructed picture buffer (111) can be upsampled by the upsample unit (105) into the resolution used by the enhancement layer coding loop (106). The enhancement layer coding loop (106) can use the upsampled base layer reference picture as produced by the upsample unit (105) in conjunction with the input picture coming from the video input (101), and reference pictures (112) created as part of the enhancement layer coding loop in its coding process. The nature of these uses depends on the video coding standard, and has already been briefly introduced for some video compression standards above. The enhancement layer coding loop (106) can create an enhancement layer bitstream (113), which can be processed together with the base layer bitstream (110) and control information (not shown) so to create a scalable bitstream (114).

The enhancement layer coding loop (106) can include a motion vector coding unit (115), that can operate in accordance with WD6, which is summarized above.

### SUMMARY

The disclosed subject matter provides techniques for prediction of a to-be-reconstructed block using motion vector information of the base layer, where video is represented in the form of a base layer and one or more additional layers.

In one embodiment, a video encoder includes an enhancement layer coding loop with a predictor list insertion module.

In one embodiment, a decoder can include an enhancement layer decoder with a predictor list insertion module.

In one embodiment, the predictor list insertion module in an enhancement layer encoder/decoder can generate a list of motion vector predictors, or modify an existing list of motion vector predictors, such that the list includes at least one predictor that is derived from side information generated by a base layer coding loop, and has been upscaled.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an exemplary scalable video encoder in accordance with Prior Art;

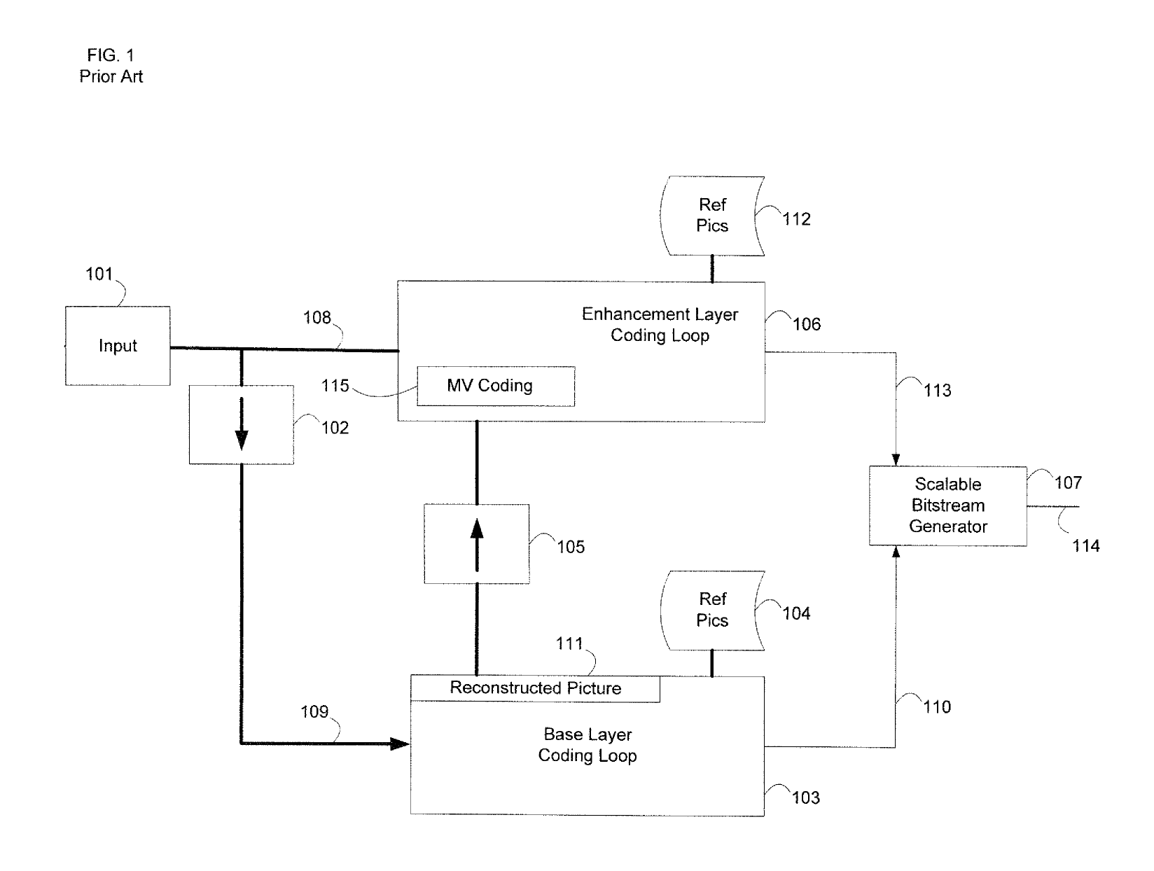

FIG. 2 is a schematic illustration of an exemplary encoder in accordance with an embodiment of the present disclosure;

FIG. 3 is a schematic illustration of an exemplary decoder in accordance with an embodiment of the present disclosure;

FIG. 4 is a schematic illustration of an exemplary predictor list insertion module in accordance with an embodiment of the present disclosure;

FIG. 5 is a procedure for an exemplary predictor list insertion module in accordance with an embodiment of the present disclosure; and

FIG. 6 shows an exemplary computer system in accordance with an embodiment of the present disclosure.

The Figures are incorporated and constitute part of this disclosure. Throughout the Figures the same reference numerals and characters, unless otherwise stated, are used to denote like features, elements, components or portions of the illustrated embodiments. Moreover, while the disclosed subject matter will now be described in detail with reference to the Figures, it is done so in connection with the illustrative embodiments.

### DETAILED DESCRIPTION

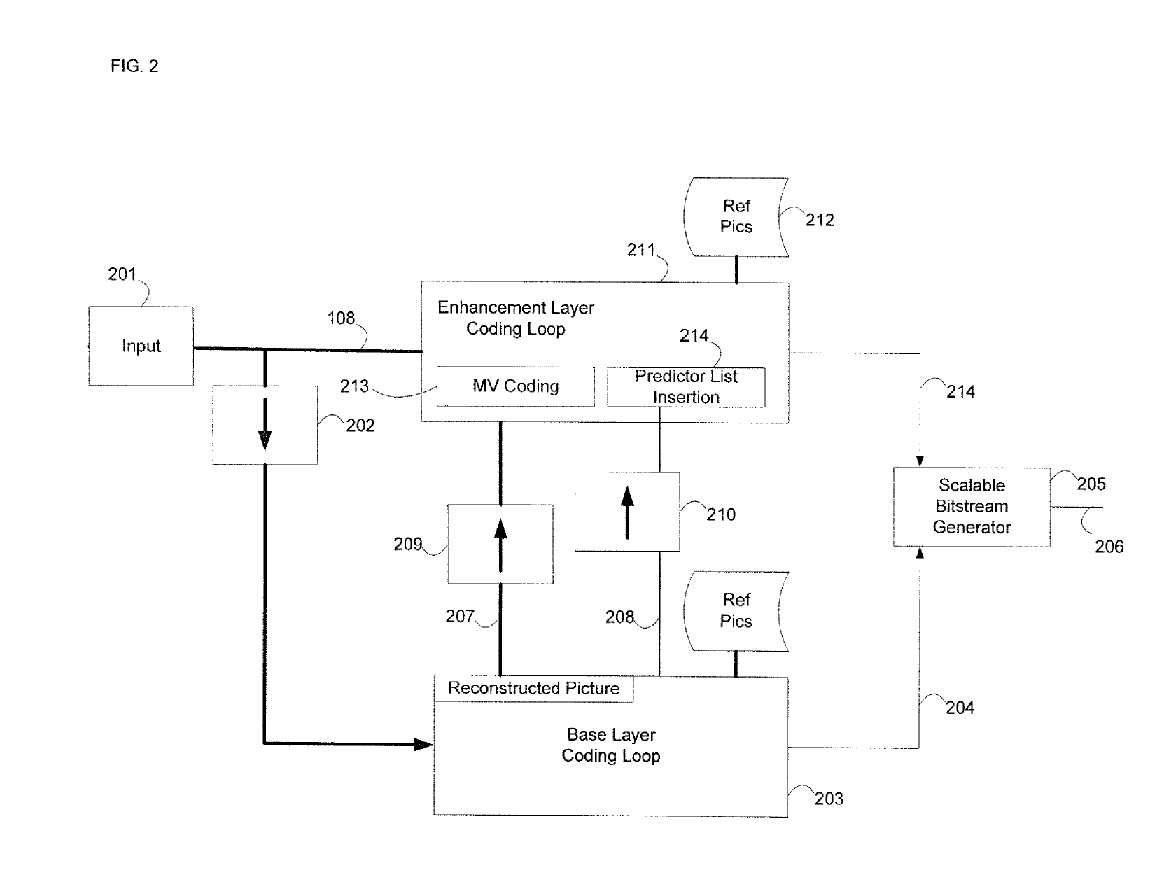

FIG. 2 shows a block diagram of an exemplary two layer scalable encoder in accordance with the disclosed subject matter. The encoder can be extended to support more than two layers by adding additional enhancement layer coding loops. One design consideration in the design of this encoder has been to keep the enhancement layer coding loop as close as feasible in terms of its operation to the base layer coding loop, by re-using essentially unchanged as many of the functional building blocks of the base layer coding loop as feasible. Doing so can save design and implementation time, which has commercial advantages.

Throughout the description of the disclosed subject matter the term “base layer” refers to the layer in the layer hierarchy on which the enhancement layer is based on. In environments with more than two enhancement layers, the base layer, as used in this description, does not need to be the lowest possible layer.

The encoder can receive uncompressed input video (201), which can be downsampled in a downsample module (202) to base layer spatial resolution, and can serve in downsampled form as input to the base layer coding loop (203). The downsample factor can be 1.0, in which case the spatial dimensions of the base layer pictures are the same as the spatial dimensions of the enhancement layer pictures (and the downsample operation is essentially a no-op); resulting in a quality scalability, also known as SNR scalability. Downsample factors larger than 1.0 lead to base layer spatial resolutions lower than the enhancement layer resolution. A video coding standard can put constraints on the allowable range for the downsampling factor. The factor can also be dependent on the application.

The base layer coding loop can generate the following output signals used in other modules of the encoder:

A) Base layer coded bitstream bits (204) which can form their own, possibly self-contained, base layer bitstream, which can be made available for examples to decoders (not shown), or can be aggregated with enhancement layer bits and control information to a scalable bitstream generator (205), which can, in turn, generate a scalable bitstream (206).

B) Reconstructed picture (or parts thereof) (207) of the base layer coding loop (base layer picture henceforth), in the pixel domain, of the base layer coding loop that can be used for cross-layer prediction. The base layer picture can be at base layer resolution, which, in case of SNR scalability, can be the same as enhancement layer resolution. In case of spatial scalability, base layer resolution can be different, for example lower, than enhancement layer resolution.

C) Reference picture side information (208). This side information can include, for example information related to the motion vectors that are associated with the coding of the reference pictures, macroblock or Coding Unit (CU) coding modes, intra prediction modes, and so forth. The “current” reference picture (which is the reconstructed current picture or parts thereof) can have more such side information associated with than older reference pictures.

Base layer picture and side information can be processed by an upsample unit (209) and an upscale units (210), respectively, which can, in case of the base layer picture and spatial scalability, upsample the samples to the spatial resolution of the enhancement layer using, for example, an interpolation filter that can be specified in the video compression standard. In case of the upscale unit (210) and reference picture side information, equivalent, for example scaling, transforms can be used. For example, motion vectors can be scaled by multiplying, in both X and Y dimension, the vector generated in the base layer coding loop (203).

An enhancement layer coding loop (211) can contain its own reference picture buffer(s) (212), which can contain reference picture sample data generated by reconstructing coded enhancement layer pictures previously generated, as well as associated side information.

The enhancement layer coding loop (211) can further include a motion vector coding module, whose function has already been described.

In an embodiment of the disclosed subject matter, the enhancement layer coding loop further includes a predictor list insertion module (214). The predictor list insertion module (214) can be coupled to the output of the upscale unit (210), from which it can receive side information including motion vector(s), potentially including the third dimension component such as an index into a reference picture list, which can be used as a predictor for the coding of the current PU. It can further be coupled to the motion vector coding module, and, specifically, can access and manipulate the motion vector predictor list that can be stored therein. The predictor list insertion module (214) can operate in the context of the enhancement layer encoding (211), and can, therefore, have available information for motion vector prediction generated both during the processing of the current PU (such as, for example, the results of a motion vector search) and previously processed PUs (such as, for example, the motion vectors of surrounding PUs which can be used as predictors for the coding of the current PU's motion vector).

In the same or another embodiment of the disclosed subject matter, one purpose of the predictor list module (214) is to generate a list of motion vector predictors, or modify an existing list of motion vector predictors, such that the list includes at least one predictor that is derived from side information (208) that has been upscaled by the upscale unit (210).

The generation or modification of the list of motion vector predictors can follow the techniques already used in the enhancement layer coding loop in the case of using an enhancement layer motion vector, for example as described earlier in the context of the description of WD6 ([0011] through [0013]).

Motion vector coding can be performed, for example, by selecting one of the predictors of the modified or generated list of motion vector predictors using, for example, rate-distortion optimization techniques, coding an index into the list of motion vector predictors indicative of the motion vector predictor, and optionally coding a motion vector that can be interpreted as a delta information relative to the motion vector predictor selected.

The result of the aforementioned operations can be that a predictor can be chosen, for example based on rate-distortion optimization techniques, that is referring to inter-layer prediction (predicting from a base layer reference picture) or intra layer prediction (predicting from an enhancement layer reference picture). The possible prediction from the base layer allows for a potential increase in coding efficiency.

While the predictor list insertion module (214) has been described above in the context of an encoder, in the same or another embodiment, a similar module can be present in a decoder.

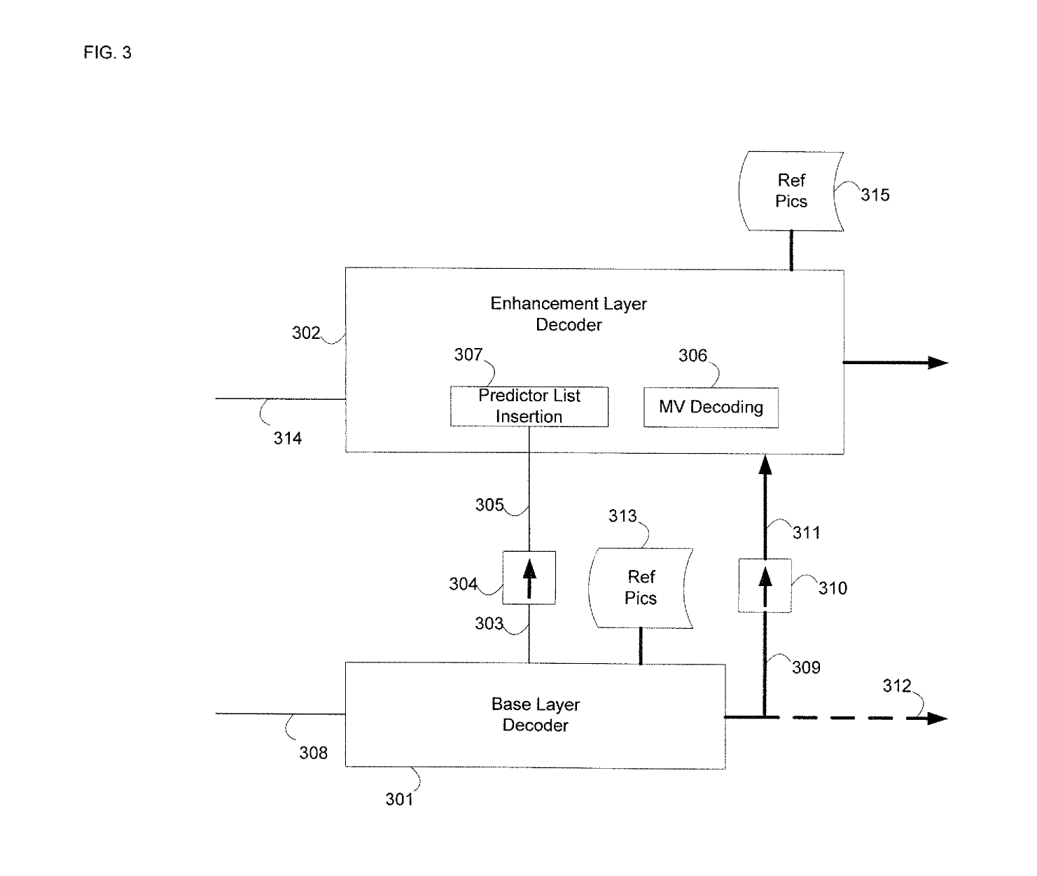

Referring to FIG. 3, shown is a scalable decoder configured to decode a base layer and an enhancement layer (for example a spatial or SNR enhancement layer). The decoder can include a base layer decoder (301) and an enhancement layer decoder (302). The base layer decoder (301), can generate from the base layer bitstream (308), as part of its decoding process and among other things such as reconstructed picture samples (309), which can be upscaled by upscale unit (310) and input in upsampled form (311) in the enhancement layer encoder (302). In some applications, the reconstructed base layer samples can also be output directly (shown in dashed line emphasizing that it is an option) (312). Further, the base layer decoder (301) can create side information (303), which can be upscaled by an upscale unit (304) to reflect the picture size ratio between base layer and enhancement layer. The upscaled side information (305) can include motion vector(s). The base layer decoder (302) can be based on inter picture prediction principles, for which it can use reference picture(s) that can be stored in a base layer decoder reference picture buffer (313).

The enhancement layer decoder (302) can include a motion vector decoding module (306), configured to create, for a PU, a motion vector that can be used for motion compensation by other parts of the enhancement layer decoder (302). The motion vector decoding module (306) can operate on a list of candidate motion vector predictors. The list can contain motion vector candidates that can be recreated from the enhancement layer bitstream using, for example, the motion vectors of spatially or temporally adjacent PUs that have already been decoded. The content of this list can be identical to the list that is created by an encoder when encoding the same PU.

In an embodiment of the disclosed subject matter, the enhancement layer decoder can further include a predictor list insertion module (307). Purpose and operation of this module can be the same as the predictor list insertion module of the encoder (FIG. 2, 214). Specifically, one purpose of the predictor list module (307) is to generate a list of motion vector predictors, or modify an existing list of motion vector predictors, such that the list includes at least one predictor that is derived from upscaled side information recreated by the base layer decoder.

The enhancement layer decoder decodes an enhancement layer bitstream (314), and can use for inter picture prediction one or more enhancement layer reference pictures that can be stored in an enhancement layer reference picture buffer (315).

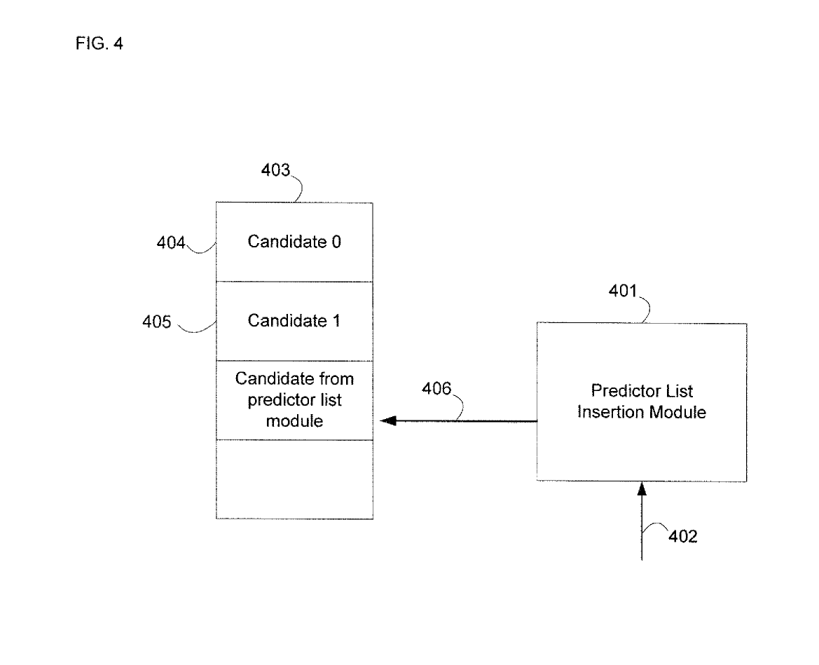

Referring to FIG. 4, shown is the operation of a predictor list insertion module (which can be located in the encoder (214) or the decoder (307)), as already described.

In the same or another embodiment, the predictor list insertion module (401) receives one or more upscaled motion vectors (402). The motion vectors can be two dimensional, or three dimensional, including, for example, an index in a reference picture list, or another form of reference picture selection.

The predictor list insertion module (401) also has access to a motion vector predictor list (403), that can be stored elsewhere, for example in a motion coding module. The list can include zero, one or more entries (two entries shown, (404) and (405)).

In the same or another embodiment, the predictor list insertion module (401) inserts a single motion vector into the list that is derived as follows.

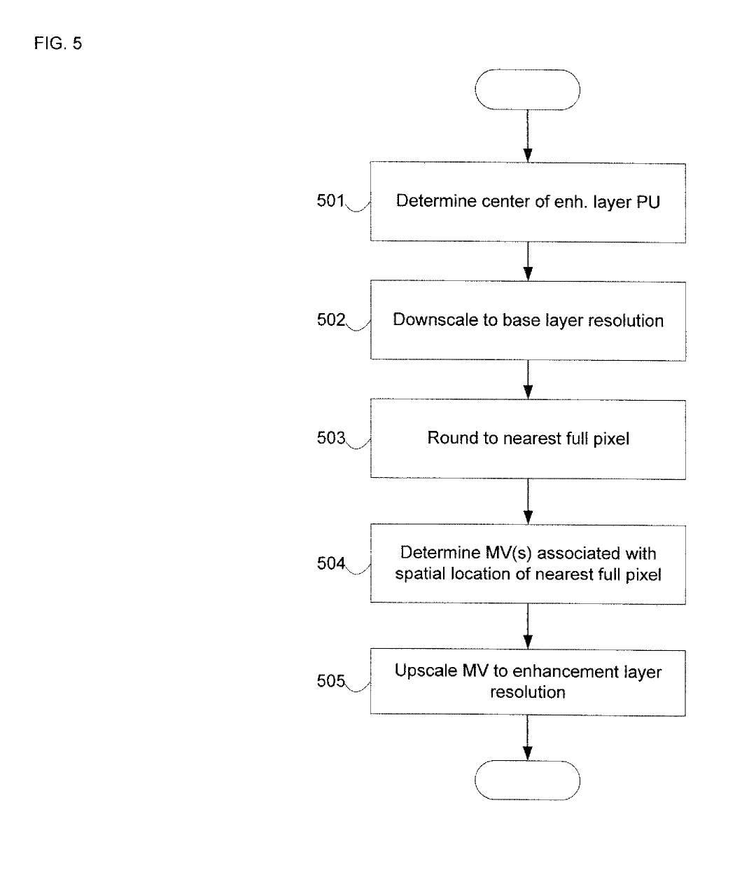

FIG. 5 shows a procedure for a predictor list insertion module in accordance with an embodiment of the disclosed subject matter. The spatial address of the center of the enhancement layer PU currently being coded is determined (501). This spatial address is downscaled to base layer resolution (which is the inverse of the upscale mechanism) (502). The result, after rounding (503) is a spatial location of a pixel in the base layer. The motion vector of this base layer pixel is determined (504), and upscaled to enhancement layer resolution (505).

The determination of the motion vector in the base layer (504) can involve a lookup into stored base layer motion vector information that is used for base layer motion vector prediction.

Referring again to FIG. 4, in the same or another embodiment, the single motion vector is inserted at the end (406) of the motion vector predictor list (403).

It has already been pointed out that the location of a motion vector predictor in the list determines the number of bits it is coded in when forming the bitstream. The end of the list can be chosen, because, for some content, the likelihood of the upscaled base vector to be chosen as predictor can be lower than for other candidates, such as the vectors of enhancement layer PUs adjacent to the PU currently being coded

In the same or another embodiment, the location for the insertion is being determined by high layer syntax structures such as entries in CU headers, slice headers or parameter sets.

In the same or another embodiment, the location for the insertion is explicitly signaled in the PU header.

In the same or another embodiment, more than one upscaled base layer motion vectors are inserted as candidate predictors in suitable positions in the motion vector predictor list. For example, in the same or another embodiment, all motion predictor candidates that have been determined during the coding of the base layer PU (the base layer PU which includes the base layer pixel determined in steps (502) and (503)) can be upsealed and inserted in suitable positions, for example at the end, of the motion vector predictor list.

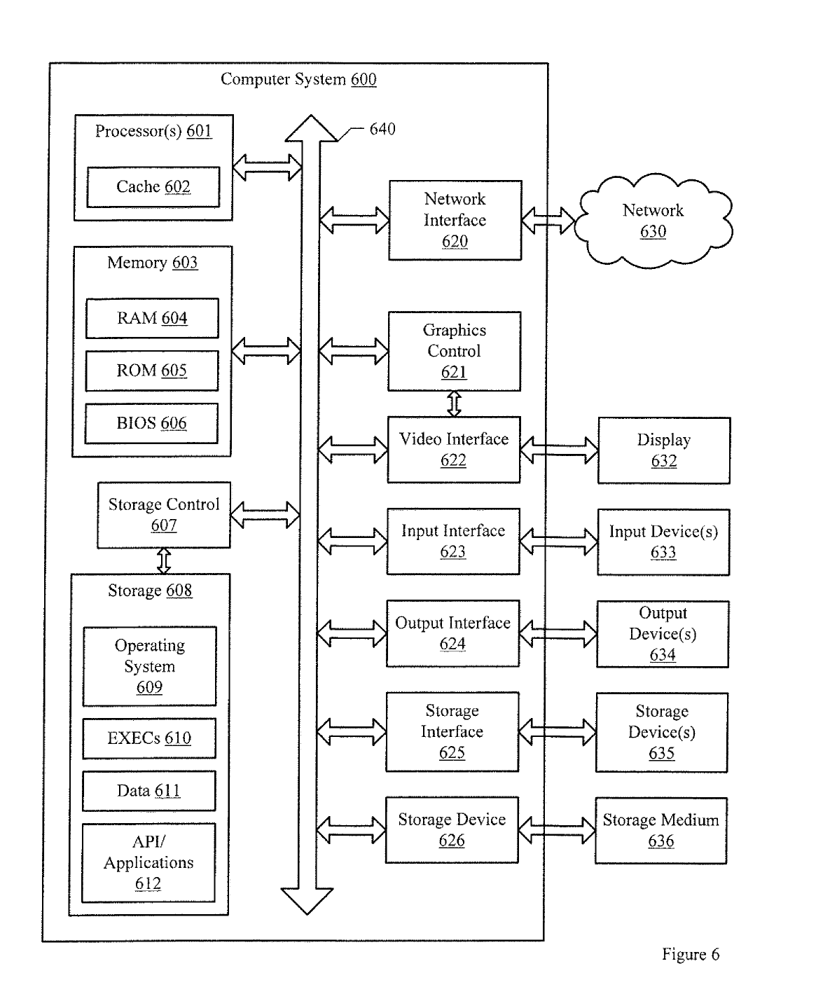

The methods for motion prediction in scalable video coding, described above, can be implemented as computer software using computer-readable instructions and physically stored in computer-readable medium. The computer software can be encoded using any suitable computer languages. The software instructions can be executed on various types of computers. For example, FIG. 6 illustrates a computer system 600 suitable for implementing embodiments of the present disclosure.

The components shown in FIG. 6 for computer system 600 are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system. Computer system 600 can have many physical foxius including an integrated circuit, a printed circuit, board, a small handheld device (such as a mobile telephone or PDA), a personal computer or a super computer.

Computer system 600 includes a display 632, one or more input devices 633 (e.g., keypad, keyboard, mouse, stylus, etc.), one or more output devices 634 (e.g., speaker), one or more storage devices 635, various types of storage medium 636.

The system bus 640 link a wide variety of subsystems. As understood by those skilled in the art, a “bus” refers to a plurality of digital signal lines serving a common function. The system bus 640 can be any of several types of bus structures including a memory bus, a peripheral bus, and a local bus using any of a variety of bus architectures. By way of example and not limitation, such architectures include the Industry Standard Architecture (ISA) bus, Enhanced ISA (EISA) bus, the Micro Channel Architecture (MCA) bus, the Video Electronics Standards Association local (VLB) bus, the Peripheral Component Interconnect (PCI) bus, the PCI-Express bus (PCI-X), and the Accelerated Graphics Port (AGP) bus. Processor(s) 601 (also referred to as central processing units, or CPUs) optionally contain a cache memory unit 602 for temporary local storage of instructions, data, or computer addresses. Processor(s) 601 are coupled to storage devices including memory 603. Memory 603 includes random access memory (RAM) 604 and read-only memory (ROM) 605. As is well known in the art, ROM 605 acts to transfer data and instructions uni-directionally to the processor(s) 601, and RAM 604 is used typically to transfer data and instructions in a bi-directional manner. Both of these types of memories can include any suitable of the computer-readable media described below.

A fixed storage 608 is also coupled bi-directionally to the processor(s) 601, optionally via a storage control unit 607. It provides additional data storage capacity and can also include any of the computer-readable media described below. Storage 608 can be used to store operating system 609, EXECs 610, application programs 612, data 611 and the like and is typically a secondary storage medium (such as a hard disk) that is slower than primary storage. It should be appreciated that the information retained within storage 608, can, in appropriate cases, be incorporated in standard fashion as virtual memory in memory 603.

Processor(s) 601 is also coupled to a variety of interfaces such as graphics control 621, video interface 622, input interface 623, output interface 624, storage interface 625, and these interfaces in turn are coupled to the appropriate devices. In general, an input/output device can be any of: video displays, track balls, mice, keyboards, microphones, touch-sensitive displays, transducer card readers, magnetic or paper tape readers, tablets, styluses, voice or handwriting recognizers, biometrics readers, or other computers. Processor(s) 601 can be coupled to another computer or telecommunications network 630 using network interface 620. With such a network interface 620, it is contemplated that the CPU 601 might receive information from the network 630, or might output information to the network in the course of performing the above-described method. Furthermore, method embodiments of the present disclosure can execute solely upon CPU 601 or can execute over a network 630 such as the Internet in conjunction with a remote CPU 601 that shares a portion of the processing.

According to various embodiments, when in a network environment, i.e., when computer system 600 is connected to network 630, computer system 600 can communicate with other devices that are also connected to network 630. Communications can be sent to and from computer system 600 via network interface 620. For example, incoming communications, such as a request or a response from another device, in the form of one or more packets, can be received from network 630 at network interface 620 and stored in selected sections in memory 603 for processing. Outgoing communications, such as a request or a response to another device, again in the form of one or more packets, can also be stored in selected sections in memory 603 and sent out to network 630 at network interface 620. Processor(s) 601 can access these communication packets stored in memory 603 for processing.

In addition, embodiments of the present disclosure further relate to computer storage products with a computer-readable medium that have computer code thereon for performing various computer-implemented operations. The media and computer code can be those specially designed and constructed for the purposes of the present disclosure, or they can be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as optical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher-level code that are executed by a computer using an interpreter. Those skilled in the art should also understand that term “computer readable media” as used in connection with the presently disclosed subject matter does not encompass transmission media, carrier waves, or other transitory signals.

As an example and not by way of limitation, the computer system having architecture 600 can provide functionality as a result of processor(s) 601 executing software embodied in one or more tangible, computer-readable media, such as memory 603. The software implementing various embodiments of the present disclosure can be stored in memory 603 and executed by processor(s) 601. A computer-readable medium can include one or more memory devices, according to particular needs. Memory 603 can read the software from one or more other computer-readable media, such as mass storage device(s) 635 or from one or more other sources via communication interface. The software can cause processor(s) 601 to execute particular processes or particular parts of particular processes described herein, including defining data structures stored in memory 603 and modifying such data structures according to the processes defined by the software. In addition or as an alternative, the computer system can provide functionality as a result of logic hardwired or otherwise embodied in a circuit, which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

We claim:

1. A method for decoding video that includes a base layer and at least one enhancement layer, comprising:
decoding at least one motion vector of the base layer;
using the at least one motion vector of the base layer as a candidate for a motion vector of the enhancement layer; and
selecting the candidate for a motion vector as a motion vector for the enhancement layer.

2. The method of claim 1, further comprising:
upscaling the motion vector of the base layer.

3. The method of claim 1, wherein the using of the motion vector of the base layer further comprises inserting the motion vector in a list of enhanced layer motion vector candidates.

4. The method of claim 3, wherein the using of the motion vector of the base layer comprises inserting the motion vector at the end of a list of enhanced layer motion vector candidates.

5. The method of claim 3, wherein the using of the motion vector of the base layer comprises inserting the motion vector at a position in a list of enhanced layer motion vector candidates indicated by a syntax element.

6. The method of claim 5, wherein the syntax element is part of a high layer syntax structure.

7. A method for encoding video that includes a base layer and at least one enhancement layer, comprising:
determining at least one motion vector of the base layer;
encoding the at least one motion vector of the base layer;
using the at least one motion vector of the base layer as a candidate for a motion vector of the enhancement layer; and
selecting the candidate for a motion vector as a motion vector for the enhancement layer.

8. The method of claim 7, further comprising:
upscaling the motion vector of the base layer.

9. The method of claim 7, wherein the using of the motion vector of the base layer further comprises inserting the motion vector in a list of enhanced layer motion vector candidates.

10. The method of claim 9, wherein the using of the motion vector of the base layer comprises inserting the motion vector at the end of a list of enhanced layer motion vector candidates.

11. The method of claim 9, wherein the using of the motion vector of the base layer comprises inserting the motion vector at a position in a list of enhanced layer motion vector candidates indicated by a syntax element.

12. The method of claim 11, wherein the syntax element is part of a high layer syntax structure.

13. An enhancement layer video decoder comprising:
a predictor list insertion module configured to:
receive an unsealed base layer motion vector from an upscale unit,
insert the unsealed base layer motion vector into a list of enhancement layer motion vector candidates, and
a motion compensation module coupled to the insertion module, the compensation module being configured to motion compensate at least one prediction unit with a motion vector that is based on at least one entry of the list of motion vector candidates.

14. The enhancement layer video decoder of claim 13, wherein the predictor list insertion module is further configured to insert the upscaled base layer motion vector at the end of the list of enhancement layer motion vector candidates.

15. The enhancement layer video decoder of claim 13, wherein the predictor list insertion module is further configured to insert the upscaled base layer motion vector at the position in the list of enhancement layer motion vector candidates indicated by a syntax element.

16. An enhancement layer video encoder comprising:
a predictor list insertion module configured to:
receive an upsealed base layer motion vector from an upscale unit,
insert the upscaled base layer motion vector into a list of enhancement layer motion vector candidates, and
a motion compensation module configured to motion compensate at least one prediction unit with a motion vector that is based on at least one entry of the list of motion vector candidates.

17. The enhancement layer video encoder of claim 16, wherein the predictor list insertion module is further configured to insert the upscaled base layer motion vector at the end of the list of enhancement layer motion vector candidates.

18. The enhancement layer video encoder of claim 10, wherein the predictor list insertion module is further configured to insert the upscaled base layer motion vector at the position in the list of enhancement layer motion vector candidates indicated by a syntax element.

19. A non-transitory computer readable medium comprising a set of instructions to direct a processor to perform the methods of one of claims 1 to 12.
